(19) United States
(12) Patent Application Publication
(10) Pub. No.: US 2014/0072740 A1
(43) Pub. Date: Mar. 13, 2014

(54) METHOD AND APPARATUS FOR RESIN FILM INFUSION

(71) Applicant: GENERAL PLASTICS & COMPOSITES, L.P., Houston, TX (US)

(72) Inventors: Jarrad ZAISER, Missouri City, TX (US); Cody NICHOLSON, Houston, TX (US)

(73) Assignee: GENERAL PLASTICS & COMPOSITES, L.P., Houston, TX (US)

(21) Appl. No.: 14/018,925

(22) Filed: Sep. 5, 2013

Related U.S. Application Data
(60) Provisional application No. 61/698,038, filed on Sep. 7, 2012.

(51) Int. Cl. C03C 25/14

(52) U.S. Cl. CPC C03C 25/14
USPC 428/35.7; 427/177; 427/178; 118/325; 118/600; 428/375

(57) ABSTRACT

In this disclosure, filament winding method and system without a resin dip bath are disclosed. The method comprises feeding a fiber on a mandrel without dipping the fiber in a resin bath; and applying a resin onto the fiber at the point of where the fiber contacts the mandrel. In an embodiment, the fiber comprises carbon fiber, basalt fiber, S-glass fiber, S-2 glass fiber, A-glass fiber, C-glass fiber, E-glass fiber, D-glass fiber, Kevlar fiber, ECR glass fiber. In an embodiment, the resin comprises polyester resin, vinylester resin, epoxy resin, phenolic resin, BMI resin, polyurethane resin, cyanate ester resin. In an embodiment, the fiber is fed on the mandrel at an angle of from about 25° to 65°, wherein the angle is defined as the angle between the fiber and a horizontal plane when the mandrel is placed horizontally. Further disclosed are parts made according to the instant filament winding method.

### CROSS-REFERENCE TO RELATED APPLICATIONS

This application claims the benefit under 35 U.S.C. §119(e) of U.S. Provisional Patent Application No. 61/698,038 filed Sep. 7, 2012 the disclosure of which is hereby incorporated herein by reference.

### STATEMENT REGARDING FEDERALLY SPONSORED RESEARCH OR DEVELOPMENT

Not Applicable.

### TECHNICAL FIELD

This invention relates generally to the field of filament winding. More specifically, this invention relates to method and apparatus for resin film infusion during a filament winding process.

### BACKGROUND

Filament winding is a fabrication technique for manufacturing composite material, usually in the form of cylindrical structures. The process involves winding filaments under varying amounts of tension over a male mould or mandrel. The mandrel rotates while a carriage moves horizontally (x direction as shown in FIG. 3, laying down fibers in the desired pattern. The most common filaments are carbon or glass fiber and are coated with thermoset resin as they are wound. Once the mandrel is completely covered to the desired thickness, the mandrel is placed in an oven to solidify (set or cure) the resin. Once the resin has cured, the mandrel is removed, leaving the hollow billet.

Filament winding is well suited to automation, where the tension on the filaments can be carefully controlled. Filaments that are applied with high tension results in a final product with higher rigidity and strength; lower tension results in more flexibility. The orientation of the filaments can also be carefully controlled so that successive layers are plied or oriented differently from the previous layer. The angle at which the fiber is laid down will determine the properties of the final product. A high angle “hoop” 90° will provide crush strength, while a lower angle pattern, 0°, (known as a closed or helical) will provide greater tensile strength, shown in FIG. 3.

The simplest winding machines have two axes of motion, the mandrel rotation and the carriage travel (usually horizontal). Two axis machines are best suited to the manufacture of pipes. For pressure vessels such as LPG or CNG containers (for example) it is normal to have a four axis winding machine. A four-axis machine additionally has a radial (cross-feed) axis perpendicular to carriage travel and a rotating fiber payout head mounted to the cross-feed axis. The head rotation can be used to stop the fiber band twisting and thus varying in width during winding.

Filament winding can also be described as the manufacture of parts with high fiber volume fractions and controlled fiber orientation. Conventionally, fiber tows are immersed in a resin bath where they are coated with low or medium molecular weight reactants (such as a resin). The impregnated tows are then literally wound around a mandrel (mold core) in a controlled pattern to form the shape of the part. After winding, the resin is then cured, typically using heat. The mold core may be removed or may be left as an integral component of the part. This process is primarily used for hollow, generally circular or oval sectioned components, such as pipes and tanks. Pressure vessels, pipes and drive shafts have all been manufactured using filament winding. It has been combined with other fiber application methods such as hand layup, pultrusion, and braiding. Compaction is through fiber tension and resin content is primarily metered.

The fibers may be impregnated with resin before winding (wet winding), pre-impregnated (dry winding) or post-impregnated. Wet winding is able to use low-cost materials with long storage life and relatively low viscosity. The pre-impregnated systems produce parts with more consistent resin content and can often be wound faster.

Glass fiber is the fiber most frequently used for filament winding, carbon fibers, aramid fibers, basalt fibers, and boron fibers are also used. Most high strength critical aerospace structures are produced with epoxy resins, with either vinylester or cheaper polyester resins being specified for most other applications. Other than epoxy resins, polyester resins, vinylester resins, and phenolic resins may also be used for filament winding. After the fibers are wound and the resins impregnated, the resulting component is normally cured at high temperature before removing the mandrel. Finishing operations include machining or grinding. In some cases, finishing operations are not needed to produce the final products.

Filament winding is currently being used to produce products such as golf clubs, pipes, oars, bicycle forks, power and transmission poles, pressure vessels, missile casings, aircraft fuselages, lamp posts and yacht masts. There is continuing interest in developing method and apparatus for a filament winding process.

### SUMMARY

In an embodiment of this disclosure, a filament winding method is disclosed, the method comprising feeding a fiber on a mandrel without dipping the fiber in a resin bath; and applying a resin onto the fiber at the point of where the fiber contacts the mandrel. In an embodiment, the fiber comprises carbon fiber, basalt fiber, S-glass fiber, S-2 glass fiber, A-glass fiber, C-glass fiber, E-glass fiber, D-glass fiber, Kevlar fiber, ECR glass fiber. In an embodiment, the resin comprises polyester resin, vinylester resin, epoxy resin, phenolic resin, BMI resin, polyurethane resin, cyanate ester resin.

In an embodiment, the method comprises utilizing an injection pump to apply the resin. In an embodiment, the method comprises controlling the flow rate of the injection pump to apply the resin. In an embodiment, the injection pump is integrated with the filament winder. In an embodiment, the injection pump is integrate with filament winder via a programmable logic controller or a variable frequency drive.

In an embodiment, the fiber is fed on the mandrel at an angle of from about 25° to 65°, wherein the angle is defined as the angle between the fiber and a horizontal plane when the mandrel is placed horizontally. In an embodiment, the method comprises controlling the flow rate of resin while applying the resin. In an embodiment, the flow rate of resin is controlled by a flow control valve. In an embodiment, the method further comprises controlling the speed at which the fiber is wound onto the mandrel and controlling the flow rate of resin while applying the resin. In an embodiment, the method comprises coordinating the speed at which the fiber is wound onto the mandrel and the flow rate of resin being applied to the fiber such that a proper amount of resin is applied to the fiber.

In an embodiment, the resin is maintained at a predetermined temperature. In embodiments, the predetermined temperature is from about ambient to about 170° F.

Further disclosed are parts made according the method of this disclosure. Such parts include bridge or frac plug mandrels, wedges, sleeves, noses, cones, mule shoes, extrusion limiters, or tubular parts.

In another embodiment, a filament winding system without a resin dip bath is described. The system comprises a filament winder comprising a mandrel; and a resin applicator fluidly connected to a resin reservoir; wherein the filament winder and resin applicator are configured such that when a fiber is wound onto the mandrel, the resin applicator applies a resin to the fiber at the point of where the fiber contacts the mandrel.

In an embodiment, the system further comprises a resin pump or flow control valve fluidly connected to the resin applicator and the resin reservoir. In an embodiment, the resin pump or flow control valve controls the flow rate of resin applied to the fiber. In an embodiment, the resin pump is integrated with the filament winder such that the speed at which the fiber is wound onto the mandrel and the flow rate of resin being applied to the fiber are coordinated. In an embodiment, the coordination between the speed at which the fiber is wound onto the mandrel and the flow rate of resin being applied to the fiber ensures that a proper amount of resin is applied to the fiber.

In an embodiment, the resin reservoir is maintained at a predetermined temperature. In an embodiment, the resin applicator comprises a resin injector, a resin dropper, or nozzle.

In an embodiment, the filament winder is configured such that fiber is fed onto the mandrel at an angle of from about 25° to 65°, wherein the angle is defined as the angle between the fiber and a horizontal plane when the mandrel is placed horizontally.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 illustrates a process of resin film infusion during filament winding, according to certain embodiments of this disclosure.

FIG. 2 is a 2D projection (side view) of the resin film infusion process as illustrated in FIG. 1, according to certain embodiments of this disclosure.

FIG. 3 is a schematic illustration of the orientation in which the fibers are applied to the mandrel, according to certain embodiments of this disclosure.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . .”.

### DETAILED DESCRIPTION

### Overview

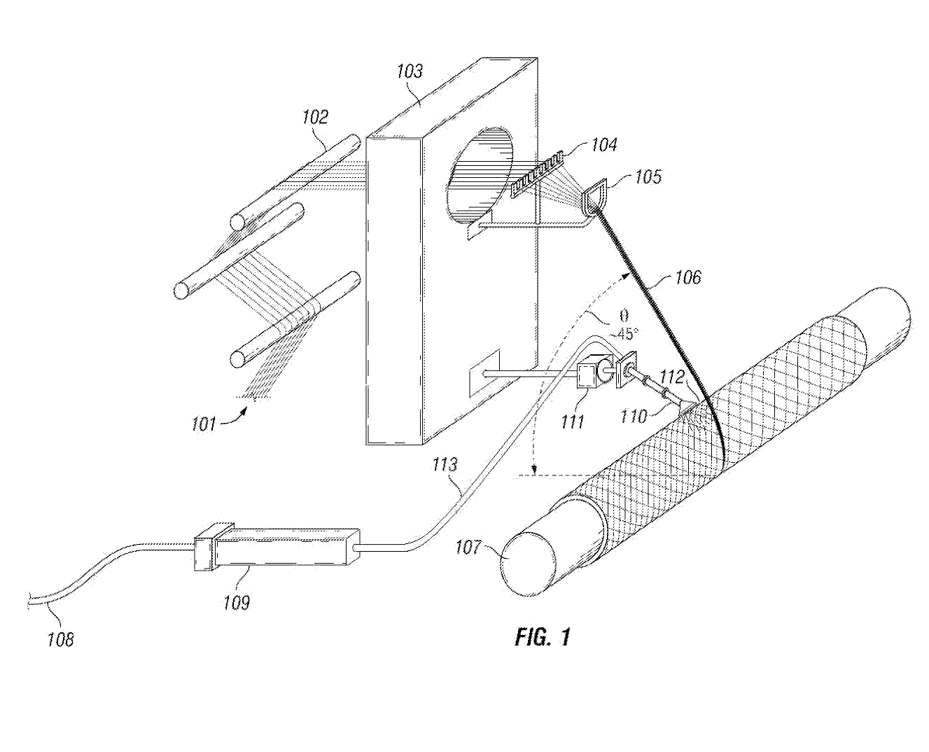

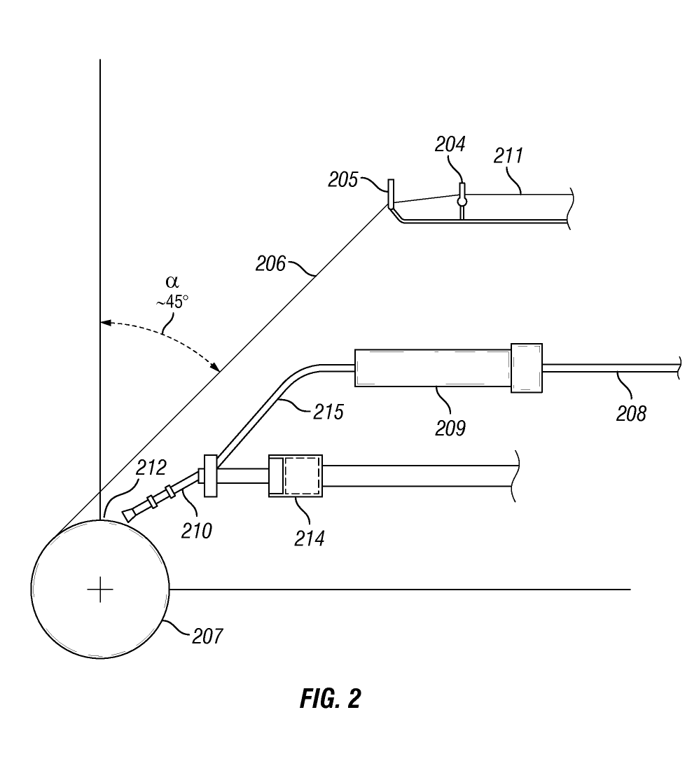

The filament winding method and system as disclosed herein eliminates the need for a dip bath that is used in traditional filament winding. Briefly, the fiber (e-glass, carbon, basalt, S-glass, etc.) is fed on the mandrel at an approximately 45° angle (with a +/−20° range) and the resin is injected/applied at the point of contact with the mandrel (e.g., 112 in FIG. 1 or 212 in FIG. 2). Detailed description of such method and system is provided below.

### Filament Winding System

In an embodiment, a filament winding system comprises a filament winder, a resin applicator, and a resin reservoir, wherein the resin applicator is fluidly connected to the resin reservoir. As illustrated in FIG. 1, the filament winder comprises mandrel 107, fiber doffs (connected via 101), tension rods 102, boom 103, comb 104, and eye 105. 106 represents fiber (e.g., glass) roving during the filament winding process. Other parts of the filament winder are known in the art and may be included in the system of this disclosure.

In an embodiment, the resin applicator comprises hose 110, resin injector 109, and hose or tube 108 that connects the injector to the resin reservoir. In some cases, resin injector 109 is a resin pump. In some embodiments, the resin applicator is an injector. In other embodiments, the resin applicator is a dropper. In some embodiments, the resin applicator is a nozzle.

In FIG. 1, 111 represents a servo controller or mechanical device that places the nozzle at the point of interest, where the glass roving meets the mandrel at point 112. 113 is a feed line that connects the pump/injector 109 to the back of the resin dispensing tube.

In an embodiment, the filament winder and resin applicator are configured such that when a fiber is wound onto the mandrel, the resin applicator applies a resin to the fiber at point 112, where the fiber contacts the mandrel.

Referring to FIG. 1, when the mandrel is placed horizontally, angle θ is defined as the angle between the fiber and a horizontal plane. In some embodiments, angle θ is in the range of from about 25° to 65°.

FIG. 2 is a 2D projection (side view) of the resin film infusion process as illustrated in FIG. 1. Angle α is defined as the angle between the fiber and a vertical plane when the mandrel is placed horizontally. And thus α+θ=90°. In FIG. 2, 206 represents fiber/glass roving; 207 is the mandrel of the filament winder; 204 is the comb; and 205 is the eye. 210 is the hose of the resin applicator; 209 is the resin injector (or pump); and 208 is the hose or tube that connects the injector to the resin reservoir. 214 is the servo that controls the movement of the application head. 212 is the contact point where the glass roving meets the mandrel.

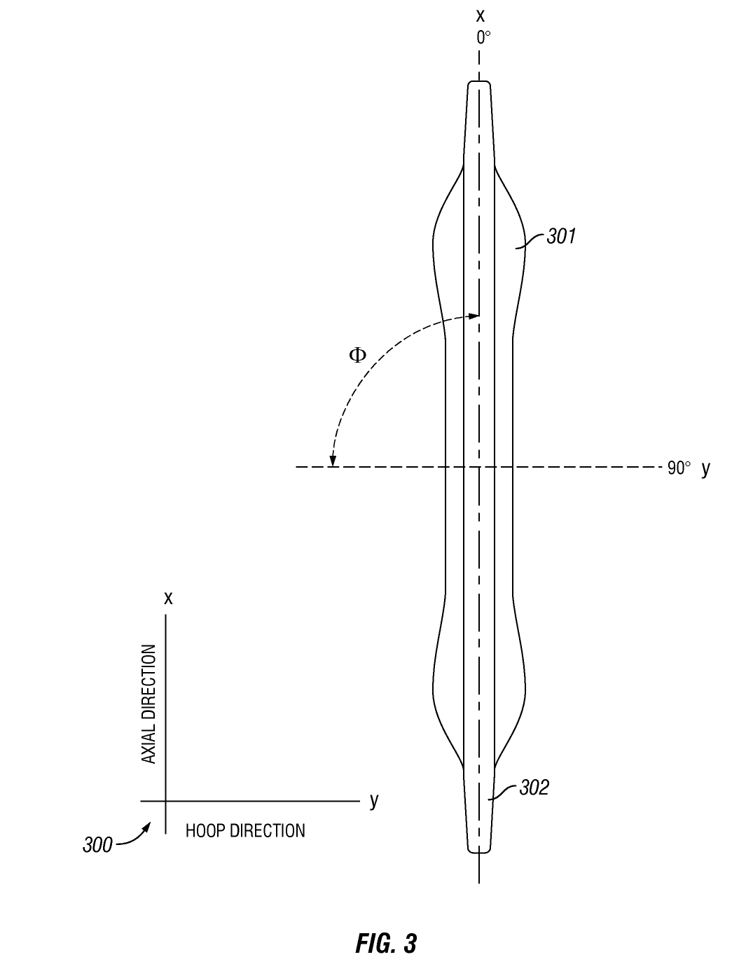

In FIG. 3, x axis is the length along the mandrel or part being made. The y axis is the direction perpendicular to the mandrel/part, e.g., the hoop. 301 represents the part. 302 is the mandrel on which the part is being wrapped. 300 represents the coordinate system of the x and y axes. Φ is the angle between the x and y axes.

In some embodiments, the filament winding system of this disclosure comprises a resin pump fluidly connected to the resin applicator and the resin reservoir. In an embodiment, the resin pump controls the flow rate of resin applied to the fiber. In some cases, the resin pump is integrated with the filament winder such that the speed at which the fiber is wound onto the mandrel and the flow rate of resin being applied to the fiber are coordinated. In an embodiment, a signal is sent from the filament winder to the pump, which signal is configured to cause adjustment of the flow rate of resin based on the speed at which the mandrel is rotating. In an embodiment, the pump and/or nozzle valve controller is integrated with the programmable logic controller (PLC) or variable frequency device (VFD) to coordinate the flow rate of resin and the rotation speed of the mandrel. The PLC may also control a servo or mechanical device which guides the resin applicator to the point of application (112 in FIG. 1 or 212 in FIG. 2).

In some embodiments, the coordination between the speed at which the fiber is wound onto the mandrel and the flow rate of resin being applied to the fiber ensures that a proper amount of resin is applied to the fiber. This way, the amount of resin wasted is reduced or minimized.

In an embodiment, the filament winding system of this disclosure comprises a heater for the resin reservoir such that the resin reservoir is maintained at a predetermined temperature. This predetermined temperature depends on the type of resin used. In some cases, it is room temperature. In other cases, this predetermined temperature is in the range of from about ambient to about 170° F.

### Filament Winding Method

In an embodiment, a filament winding method comprises feeding a fiber on a mandrel; and applying a resin onto the fiber at the point of where the fiber contacts the mandrel. FIG. 1 illustrates this process. In various embodiments, the fiber comprises carbon fiber, basalt fiber, S-glass fiber, S-2 glass fiber, A-glass fiber, C-glass fiber, E-glass fiber, D-glass fiber, Kevlar fiber, ECR glass fiber.

In various embodiments, the resin comprises polyester resin, vinylester resin, epoxy resin, phenolic resin, BMI resin, polyurethane resin, cyanate ester resin.

In an embodiment, a resin injection pump is used to apply the resin onto the fiber. In some cases, the injection pump is integrated with the filament winder.

In an embodiment, the fiber is fed on the mandrel at an angle θ of from about 25° to 65°, wherein said angle θ is defined as the angle between the fiber and a horizontal plane when the mandrel is placed horizontally.

In some embodiments, the flow rate of resin is controlled, for example, by the resin injection pump, PLC, or a variable frequency drive (VFD).

In an embodiment, the speed at which the fiber is wound onto the mandrel is controlled, for example, by controlling the rotation speed of the mandrel.

In an embodiment, the speed at which the fiber is wound onto the mandrel and the flow rate of resin being applied are both controlled. In a further embodiment, the speed at which the fiber is wound onto the mandrel and the flow rate of resin being applied to the fiber are coordinated such that a proper amount of resin is applied to the fiber.

In some embodiments, the resin is kept at a predetermined temperature. In some embodiments, the resin is kept at this predetermined temperature by maintaining the temperature of the resin reservoir. In some cases, this predetermined temperature is room temperature. In some cases, this predetermined temperature is from ambient to about 170° F.

After the part is made by the filament winder, the part may be cured by any means as known to one skilled in the art. For example, the part is put in an oven and rotated until curing is completed as desired.

### Parts and Products Made by Filament Winding

In various embodiments, the filament winding method and system as described herein produce bridge or frac plug mandrels, wedges, sleeves, noses, cones, mule shoes, extrusion limiters, or any tubular parts. As one killed in the art would recognize, these parts are not differentiated by name but only by function.

### Advantages

In certain embodiments, the resin injection pump is integrated with the filament winder and controls the flow rate of the resin, thus reducing the amount of resin wasted. In certain embodiments, the resin flow rate and the fiber winding speed are coordinated to ensure that a proper amount of resin is applied to the fiber. In various embodiments, the need for a resin bath is eliminated.

While preferred embodiments of the invention have been shown and described, modifications thereof can be made by one skilled in the art without departing from the spirit and teachings of the invention. The embodiments described herein are some only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent they provide some, procedural or other details supplementary to those set forth herein.

What is claimed is:

1. A filament winding method, the method comprising
feeding a fiber on a mandrel without dipping the fiber in a resin bath; and
applying a resin onto the fiber at the point of where the fiber contacts the mandrel.

2. The method of claim 1 wherein said fiber comprises carbon fiber, basalt fiber, S-glass fiber, S-2 glass fiber, A-glass fiber, C-glass fiber, E-glass fiber, D-glass fiber, Kevlar fiber, ECR glass fiber.

3. The method of claim 1 wherein said resin comprises polyester resin, vinylester resin, epoxy resin, phenolic resin, BMI resin, polyurethane resin, cyanate ester resin.

4. The method of claim 1 comprising utilizing an injection pump to apply said resin.

5. The method of claim 4 comprising controlling the flow rate of said injection pump to apply said resin.

6. The method of claim 4 wherein said injection pump is integrated with filament winder.

7. The method of claim 6 wherein the injection pump is integrate with filament winder via a programmable logic controller or a variable frequency drive.

8. The method of claim 1 wherein said fiber is fed on the mandrel at an angle of from about 25° to 65°, wherein said angle is defined as the angle between the fiber and a horizontal plane when the mandrel is placed horizontally.

9. The method of claim 1 comprising controlling the flow rate of resin while applying said resin.

10. The method of claim 9 wherein the flow rate of resin is controlled by a flow control valve.

11. The method of claim 1 comprising controlling the speed at which the fiber is wound onto the mandrel and controlling the flow rate of resin while applying said resin.

12. The method of claim 1 comprising coordinating the speed at which the fiber is wound onto the mandrel and the flow rate of resin being applied to the fiber such that a proper amount of resin is applied to the fiber.

13. The method of claim 1 wherein said resin is maintained at a predetermined temperature.

14. The method of claim 13 wherein said predetermined temperature is from about ambient to about 170° F.

15. A part made according to the method of claim 1.

16. The part of claim 15 comprising bridge or frac plug mandrels, wedges, sleeves, noses, cones, mule shoes, extrusion limiters, or tubular parts.

17. A filament winding system without a resin dip bath comprising
a filament winder comprising a mandrel; and
a resin applicator fluidly connected to a resin reservoir;
wherein said filament winder and resin applicator are configured such that when a fiber is wound onto said mandrel, the resin applicator applies a resin to the fiber at the point of where the fiber contacts the mandrel.

18. The system of claim 17 further comprising a resin pump or flow control valve fluidly connected to said resin applicator and said resin reservoir.

19. The system of claim 18 wherein said resin pump or flow control valve controls the flow rate of resin applied to said fiber.

20. The system of claim 18 wherein the resin pump is integrated with the filament winder such that the speed at which the fiber is wound onto the mandrel and the flow rate of resin being applied to the fiber are coordinated.

21. The system of claim 20 wherein the coordination between the speed at which the fiber is wound onto the mandrel and the flow rate of resin being applied to the fiber ensures that a proper amount of resin is applied to the fiber.

22. The system of claim 17 wherein said resin reservoir is maintained at a predetermined temperature.

23. The system of claim 17 wherein said resin applicator comprises a resin injector, a resin dropper, or nozzle.

24. The system of claim 17 wherein said filament winder is configured such that fiber is fed onto the mandrel at an angle of from about 25° to 65°, wherein said angle is defined as the angle between the fiber and a horizontal plane when the mandrel is placed horizontally.
